(19) United States
(12) Patent Application Publication
(10) Pub. No.: US 2009/0096366 A1
(43) Pub. Date: Apr. 16, 2009

(54) Organic electro-luminescent display device

(75) Inventors: Kazuhiko Kai, Mobara (JP); Eiji Matsuzaki, Yokohama (JP); Masato Ito, Mobara (JP); Noriharu Matsudate, Kujukuri (JP); Ryoji Iwamura, Yokohama (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 12/285,822

(22) Filed: Oct. 15, 2008

(30) Foreign Application Priority Data
Oct. 15, 2007 (JP) 2007-267713

(51) Int. Cl. H01J 1/62

(52) U.S. Cl. 313/504

(57) ABSTRACT

An organic EL display device which can prolong a lifetime by suppressing a growth of black spots when the display device is operated for a long time can be realized. An element substrate on which organic EL layers are formed is hermetically adhered to a sealing substrate on which a desiccant is mounted by way of a sealing portion. The element substrate and the sealing substrate are curved outwardly. Particularly, by curving the element substrate outwardly, a growth of black points can be prevented when the organic EL display device is operated for a long time. Accordingly, a lifetime of the organic EL display device can be remarkably prolonged.

### CLAIM OF PRIORITY

The present application claims priority from Japanese Application JP 2007-267713 filed on Oct. 15, 2007, the content of which is hereby incorporated by reference into this application.

### BACKGROUND OF THE INVENTION

1. Field of the Invention

The present invention relates to a display device, and more particularly to an organic EL (electro-luminescent) display device which can enhance the lifetime property of the display device by preventing the increase of pixel defects such as black spots which may be generated when the display device is operated for a long period.

2. Description of the Related Art

In view of the advantages such as a flat screen and a small panel thickness, the demand for a liquid crystal display device, an organic EL display device and the like has been increasing for use as a flat display of a monitor, a television receiver set or the like. Since the organic EL display device uses a self-luminous light and hence, the organic EL display device possesses excellent viewing angle characteristic and, at the same time, a back light becomes unnecessary whereby the application of the organic EL display device in various fields is expected as a display.

An organic EL layer is formed of a plurality of thin organic films and hence, the organic EL display device has a drawback that light emitting characteristic of the organic EL layer deteriorates in an environment where moisture is present. To cope with such a drawback, an element substrate on which the organic EL layer is formed is sealed by a sealing substrate made of glass or by a sealing cap made of metal thus protecting the organic EL layer from moisture.

JP-A-2001-118680 (patent document 1) discloses a technique which forms an organic EL display device having a curved surface using shape memory alloy for forming a sealing cap which protects an organic EL layer. That is, patent document 1 discloses the following constitution. After forming an organic EL layer or the like on a flat element substrate, the element substrate is sealed with the sealing cap formed by using shape memory alloy. Thereafter, the organic EL display device is heated to a transformation temperature of shape memory alloy or more thus imparting the curved surface to the element substrate. In this document, the element substrate projects outwardly and the sealing cap projects inwardly.

JP-A-2001-217069 (patent document 2) discloses the constitution which alleviates a thermal shock to an organic EL display device using a material which is flexibly deformed by pressure as a sealing cap. That is, an inert gas is filled in the inside of the organic EL display device where the organic EL layer is formed. When this gas expands or contracts due to a temperature change, such expansion or contraction causes a stress in a sealing portion thus deteriorating sealing property. However, with the use of the sealing cap which is deformed flexibly, this thermal shock can be alleviated. Although this document discloses the constitution where the sealing cap projects outwardly or is recessed as viewed from the outside, the element substrate and the sealing portion are held flat.

### SUMMARY OF THE INVENTION

When the moisture is present in the organic EL layer, the property of the organic EL layer deteriorates and hence, the organic EL layer no longer can emit light. Portions of the organic EL layer from which light is no longer emitted appear as black spots on a screen. When the organic EL display device is operated for a long time, an area and the number of black spots are increased. This is because the effect of moisture gradually appears over a long time. That is, although the organic EL layer is protected from the outside by sealing the element substrate using the sealing substrate by way of the sealing portion, moisture in atmospheric air gradually intrudes into the inside of the organic EL display device through the sealing portion along with a lapse of long time thus invading the organic EL layer.

The present invention is provided for prolonging a lifetime of an organic EL display device, wherein the sealing constitution of the organic EL display device is improved such that the intrusion of moisture from the outside can be suppressed thus suppressing the increase of black spots on a display screen.

The present invention has been made to overcome the above-mentioned drawbacks and provides an organic EL display device which seals an element substrate on which organic EL layers are formed using a sealing substrate by way of a sealing material, wherein by curving the element substrate toward the outside, the intrusion of moisture from the outside can be prevented thus suppressing the increase of black spots or a growth of black spot. To explain specific means of the present invention, there are as follows.

(1) The present invention provides an organic EL display device in which a sealing portion is formed on a periphery of an element substrate on which organic EL layers are formed and a sealing substrate is arranged to face the element substrate in an opposed manner with the sealing portion sandwiched therebetween, wherein the element substrate has an outwardly projecting curved surface.

(2) In the organic EL display device having the constitution (1), the sealing substrate has an outwardly projecting curved surface.

(3) In the organic EL display device having the constitution (1), assuming a long-side size of the element substrate as 2D and an outward deflection amount of the element substrate as d, d/2D is set to 1.3×10⁻⁴ or more.

(4) In the organic EL display device having the constitution (1), assuming a long-side size of the element substrate as 2D and an outward deflection amount of the element substrate as d, d/2D is set to 2.0×10⁻⁴ or more.

(5) In the organic EL display device having the constitution (1), assuming a long-side size of the element substrate as 2D and an outward deflection amount of the element substrate as d, d/2D is set to 1.3×10⁻³ or less.

(6) In the organic EL display device having the constitution (1), assuming a long-side size of the element substrate as 2D and an outward deflection amount of the element substrate as d, d/2D is set to 3.9×10⁻⁴ or less.

(7) The present invention provides an organic EL display device in which a sealing portion is formed on a periphery of an element substrate on which organic EL layers are formed and a sealing substrate is arranged to face the element substrate in an opposed manner with the sealing portion sandwiched therebetween, wherein a gas is filled in the inside of the organic EL display device, pressure in the organic EL display device is set to a positive pressure relative to the atmospheric pressure, and the element substrate has an outwardly projecting curved surface.

(8) In the organic EL display device having the constitution (7), the gas filled in the inside of the organic EL display device is nitrogen.

(9) In the organic EL display device having the constitution (7), assuming a long-side size of the element substrate as 2D and an outward deflection amount of the element substrate as d, d/2D is set to 1.3×10⁻³ or less.

(10) The present invention provides an organic EL display device in which a sealing portion is formed on a periphery of an element substrate on which organic EL layers are formed and a sealing substrate is arranged to face the element substrate in an opposed manner with the sealing portion sandwiched therebetween, wherein the sealing portion is made of an ultraviolet curing resin, the element substrate and the sealing substrate are adhered to each other with the ultraviolet curing resin sandwiched therebetween in a nitrogen atmosphere of pressure lower than the atmospheric pressure and, thereafter, the ultraviolet curing resin is cured by ultraviolet rays in a nitrogen atmosphere of pressure substantially equal to the atmospheric pressure, and the element substrate has an outwardly projecting curved surface.

(11) The present invention provides an organic EL display device in which a sealing portion is formed on a periphery of an element substrate on which organic EL layers are formed and are sealing substrate is arranged to face the element substrate in an opposed manner with the sealing portion sandwiched therebetween, wherein the sealing portion is made of an ultraviolet curing resin, the element substrate and the sealing substrate are adhered to each other with the ultraviolet curing resin sandwiched therebetween in a nitrogen atmosphere of pressure substantially equal to the atmospheric pressure and, thereafter, the ultraviolet curing resin is cured by ultraviolet rays in a nitrogen atmosphere of pressure higher than the atmospheric pressure, and the element substrate has an outwardly projecting curved surface.

According to the present invention, the element substrate on which the organic EL layers are formed is curved to the outside and hence, intrusion of moisture from the outside can be suppressed thus preventing a growth of black spot. Accordingly, it is possible to provide an organic EL display device having favorable lifetime property.

Further, according to the present invention, by curving the element substrate or the sealing substrate to the outside, a distance between the element substrate and the sealing substrate can be increased at a portion of the organic EL display device where the organic EL layers are formed. Accordingly, when pressure is applied to the element substrate or the sealing substrate from the outside, the element substrate and the sealing substrate are brought into contact with the organic EL layer thus preventing the rupture of the organic EL layer.

Further according to the present invention, in sealing the element substrate and the sealing substrate using the sealing portion made of the ultraviolet curing resin, by controlling pressure of nitrogen in the nitrogen atmosphere at the time of adhering the element substrate and the sealing substrate to each other using the ultraviolet curing resin and pressure of nitrogen in nitrogen atmosphere at the time of curing the ultraviolet curing resin, it is possible to adjust an outwardly projecting curved amount of the element substrate or the sealing substrate even when the same element substrate or the same sealing substrate is used.

### BRIEF DESCRIPTION OF DRAWINGS

FIG. 1 is a cross-sectional view of an organic EL display device according to the present invention;

FIG. 2 is a cross-sectional view of a conventional organic EL display device;

FIG. 3 is a graph showing the relationship of a deflection amount of an element substrate and a growth of black spots;

FIG. 4A to FIG. 4D are views showing a measurement method of the deflection amount of the element substrate;

FIG. 5 is a graph showing a measurement example of the deflection amount of the element substrate;

FIG. 6A and FIG. 6B are views showing a limit value of the deflection amount of the element substrate;

FIG. 7A and FIG. 7B are views showing states before the element substrate and a sealing substrate are adhered to each other;

FIG. 8 is a view showing an adhesion step of the element substrate and the sealing substrate;

FIG. 9 is a view showing a step of sealing the element substrate to the sealing substrate by curing an UV curing resin;

FIG. 10A to FIG. 10C are views showing the relationship between pressure in a nitrogen atmosphere and a cross section of the organic EL display device during manufacturing steps;

FIG. 11 is a view showing another example of adhesion step of the element substrate and the sealing substrate; and

FIG. 12 is a view showing another example of the step of sealing the element substrate to the sealing substrate by curing the UV curing resin.

### DESCRIPTION OF THE PREFERRED EMBODIMENTS

Hereinafter, the detailed constitution of the present invention is explained in conjunction with an embodiment.

### Embodiment 1

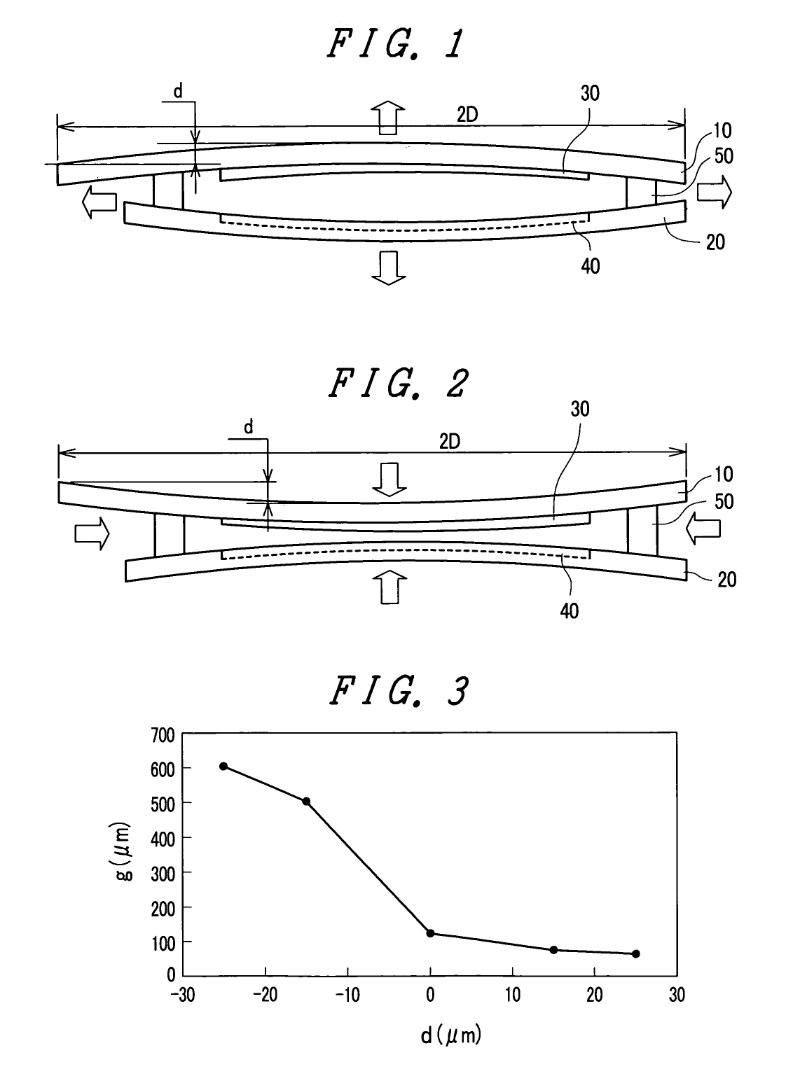

FIG. 1 is a schematic cross-sectional view of an organic EL display device according to the present invention. In FIG. 1, on an element substrate 10, besides organic EL layers 30, lines, thin film transistors (TFT) and the like are formed. The organic EL layer 30 is easily damaged by moisture and hence, the organic EL layers 30 are protected by a sealing substrate 20. In FIG. 1, the sealing substrate 20 is made of glass. The sealing substrate 20 is adhered to the element substrate 10 by a sealing portion 50 thus sealing the organic EL display device.

A recessed portion is formed on an inner side of the sealing substrate 20, and a desiccant 40 is arranged in the recessed portion (the desiccant 40 being arranged in the recessed portion while avoiding a display part in a top-emission-type organic EL display device). The desiccant 40 is provided for protecting the organic EL layers 30 from moisture by absorbing the moisture which is present in the inside of the sealed organic EL display device. An inert gas is filled in the inside of the organic EL display device having such constitution.

The present invention is characterized in that the element substrate 10 of the organic EL display device is curved so as to project outwardly. As a method for deflecting the element substrate 10 in an outwardly projecting manner, it may be possible to adopt a method in which pressure in the organic EL display device is set to a positive pressure relative to an atmospheric pressure. Here, both of the element substrate 10 and the sealing substrate 20 are curved so as to project outwardly. In such a case, a stress directed in the directions indicated by arrows shown in FIG. 1 is applied to the element substrate 10, the sealing substrate 20, the sealing portion 50 and the like. It has been found from the experiments explained later that such constitution can make it difficult for the open air to influence the inside of the organic EL display device.

FIG. 2 is a schematic cross-sectional view of a conventional organic EL display device. Constitutional parts of the organic EL display device shown in FIG. 2 are substantially equal to the constitutional parts of the organic EL display device explained in conjunction with FIG. 1. A point which makes the organic EL display device shown in FIG. 2 different from the organic EL display device shown in FIG. 1 lies in that pressure in the organic EL display device is set to a negative pressure relative to the atmospheric pressure. Accordingly, the element substrate 10, the sealing substrate 20 and the like are deflected in a recessed manner as viewed from the outside. In this case, an inwardly-directed stress indicated by arrows shown in FIG. 2 is applied to the element substrate 10, the sealing substrate 20, the sealing portion 50 and the like. Such inwardly-directed stress adversely influences a lifetime of the organic EL display device.

FIG. 3 is a view showing a comparison of a change of black spots between a case in which the element substrate 10 and the sealing substrate 20 are outwardly projected as in the case of the constitution of the present invention shown in FIG. 1 and a case in which the element substrate 10 and the sealing substrate 20 are recessed as viewed from the outside as in the case of the conventional constitution shown in FIG. 2. In FIG. 3, a deflection amount of the element substrate 10 is taken on an axis of abscissas. That is, in FIG. 1 which shows the organic EL display device of the present invention, the deflection amount d of the element substrate 10 is an outward deflection amount of the element substrate 10. On the other hand, in FIG. 2 which shows the conventional organic EL display device, the deflection amount d of the element substrate 10 is an inward deflection amount of the element substrate 10. According to an axis of abscissas in FIG. 3, when the deflection amount d takes a positive value, the element substrate 10 projects outwardly, while when the deflection amount d takes a negative value, the element substrate 10 is recessed as viewed from the outside. Here, a size 2D of the element substrate 10 is set to 76 mm.

In FIG. 3, a growth of black spots g is taken on an axis of ordinates. That is, FIG. 3 shows a result of an experiment which is performed to check how large that black spots which are originally present and have a size of 20 μm in an initial state grow. As a matter of course, it is preferable to set the growth of black spots g as small as possible. The result shown in FIG. 3 is a result of an acceleration test. That is, FIG. 3 shows the result of the experiment in which an organic EL display device is left in a thermostatic chamber held at a temperature of 40° C. and humidity of 90%, and a growth of the black spots which originally have a size of 20 μm after a lapse of 1000 hours under such condition is checked.

As shown in FIG. 3, when the deflection amount d takes a positive value, that is, when the element substrate 10 projects outwardly, the growth of the black spot is small. In this case, there is a tendency that the larger the outward projection amount d, the smaller the growth of the black spots becomes. For example, when the outward deflection amount d is 15 μm, the growth of black spots is 80 μm, and when the outward deflection amount d is 25 μm, the growth of black spots is 60 μm.

On the other hand, when the deflection amount d takes a negative value, that is, when the element substrate 10 is deflected inwardly, the growth of black spots is sharply increased. For example, when the inward deflection amount d is 15 μm, the growth of black spots is 500 μm, and when the inward deflection amount d is 25 μm, the growth of black spots is 600 μm. In this manner, the growth of black spots largely differs depending on whether the deflection of the element substrate 10 is directed outwardly or inwardly. Further, as can be understood from FIG. 3, the growth of black spots when the element substrate 10 is deflected outwardly is small compared to a case in which the element substrate is formed of a flat panel, that is, the deflection amount d is set to 0.

FIG. 3 shows the result of a measurement performed with respect to the element substrate 10. According to the structure shown in FIG. 1 and FIG. 2, when the element substrate 10 projects outwardly, the sealing substrate 20 also projects outwardly. When the element substrate 10 is recessed as viewed from the outside, the sealing substrate 20 is also recessed as viewed from the outside. The gist of the present invention is that the element substrate 10 projects outwardly.

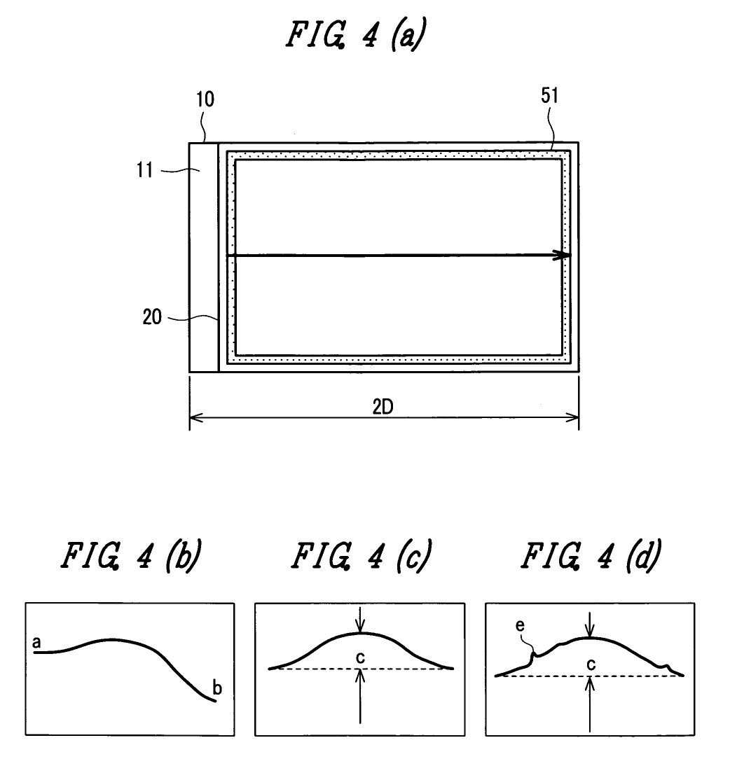

FIG. 4A is a plan view of the organic EL display device which is measured by the measuring method and apparatus explained in conjunction with FIG. 3 and FIG. 4A to FIG. 4D are views showing a measurement method of a deflection amount. FIG. 4A is a plan view of the organic EL display device. In FIG. 4A, the sealing substrate 20 is arranged on the element substrate 10 by way of the sealing portion 50 so as to face the element substrate 10 in an opposed manner. A terminal portion 11 to which an external signal source, a power source and the like are connected is formed on the element substrate 10 and hence, a size of the element substrate 10 is larger than a size of the sealing substrate 20. A terminal of a measuring apparatus is scanned in the direction indicated by an arrow in FIG. 4A. The deflection of the element substrate 10 is measured and hence, the measurement is performed on a back side of the organic EL display device shown in FIG. 4A. As the measuring apparatus, a height/surface roughness/minute form measuring apparatus P-15 made by KLA-Tencor is used.

FIG. 4B shows one example of a measurement result. Although the measurement is performed by mounting the organic EL display device on a measurement platform, the platform is inclined microscopically in general and hence, the result measured by a measurement device is obtained as inclined data as shown in FIG. 4B. To the contrary, FIG. 4C shows a measurement result obtained with a so-called leveling operation. An axis of abscissas d in FIG. 3 indicates values obtained by plotting values c in FIG. 4C. When flaws, foreign materials or the like are present on the element substrate 10, as shown in FIG. 4D, abnormal points e are generated in data partially. However, the c value in FIG. 4D is taken on the axis of abscissas d in FIG. 3 by ignoring the abnormal points e.

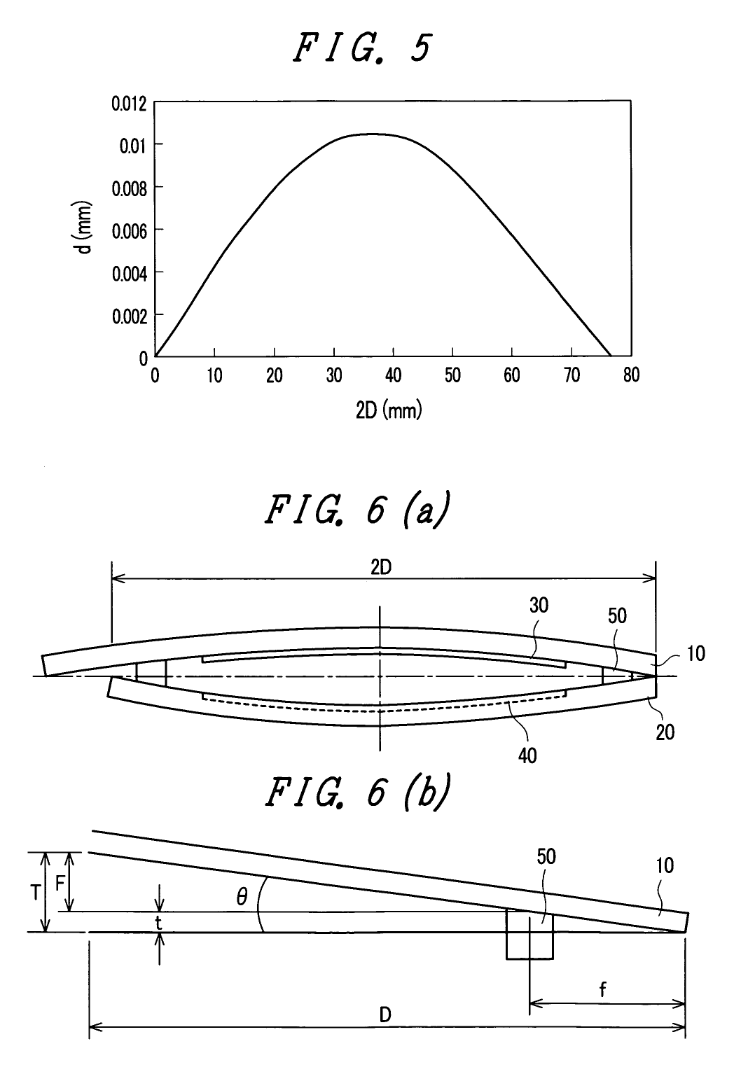

FIG. 5 shows an actual measurement example measured in the manner shown in FIG. 4A to FIG. 4D. In FIG. 5, a long-side size of the element substrate 10 is 76 mm. An outward deflection amount of the element substrate 10 is 0.012 mm, and this value is plotted on the axis of abscissas in FIG. 3. FIG. 3 shows a result of an acceleration test in which organic EL display devices are manufactured such that element substrates 10 exhibit various deflection amounts, and the measurement shown in FIG. 5 is applied to the respective organic EL display devices so as to measure the values d.

As shown in FIG. 3, when the element substrate 10 is projected outwardly, a growth of black spots is small. However, the outward projection of the element substrate 10 also has a limit. One of conditions for determining the limit is a geometric shape of the organic EL display device. FIG. 6A and FIG. 6B show the manner of determining the limit. FIG. 6A is a cross-sectional view of the organic EL display device, and FIG. 6B is a partially enlarged view of the structure shown in FIG. 6A. As shown in FIG. 6A, the sealing portion 50 is not formed on an end portion of the element substrate 10 or the sealing substrate 20, but is formed at a position inside the end portion by interval f. In this case, when the element substrate 10 or the sealing substrate 20 is deflected to project outwardly, the respective end portions of the element substrate 10 and the sealing substrate 20 are brought into contact with each other. In such a state, a force which peels off the sealing portion is strongly applied to the organic EL display device and hence, sealing property of the organic EL display device is deteriorated. Accordingly, the element substrate 10 or the sealing substrate 20 cannot be deflected to an extent that the organic EL display device assumes such a state.

FIG. 6B is a view for explaining this limit. FIG. 6B is a view which enlarges one side of the structure shown in FIG. 6A. In FIG. 6B, a distance from the center of the sealing portion 50 to the end portion of the element substrate 10 is indicated by f. As shown in FIG. 6A, a size of the organic EL display device is indicated by 2D, wherein D shown in FIG. 6B indicates a distance from the end portion of the organic EL display device to the center of the organic EL display device. In FIG. 6B, 0 is an angle made in the vicinity of the end portion due to the deflection of the element substrate 10. Further, assuming a half of a gap in the sealing portion 50 as t and a deflection amount of the element substrate 10 from the center of the sealing portion 50 to the center of the element substrate 10 as F, and a deflection amount of the element substrate 10 from the end portion of the element to the center of the substrate as T. In this case, a limit deflection amount defined by a geometrical shape is expressed as follows.

That is, following relationships are established.

t/f=tanθ=T/D (1)

T=Dt/f (2)

F≦T−t (3)

By setting D which is a half of the long-side size of the element substrate 10 to 38 mm, a half of the gap at the sealing portion 50 to 0.1 mmm, the distance f from the end portion of the element substrate 10 to the center of the sealing portion 50 to 1.2 mm, a deflection amount T from the end portion of the element substrate 10 becomes 3.2 mm, and a deflection amount F from the center of the sealing portion 50 becomes 3.1 mm. In this manner, limit deflection amounts induced from the geometrical sizes take extremely large values.

However, in the actual organic EL display device, even when such large deflection is not applied to the element substrate 10, as shown in FIG. 3, it is possible to acquire an advantageous effect sufficient to prevent a growth of black spots. As a method of deflecting the element substrate 10 of the organic EL display device outwardly, there has been known a method of deflecting the element substrate 10 and the sealing substrate 20 in which the element substrate 10 and the sealing substrate 20 are bulged by setting pressure in an organic EL display device to positive pressure. In this case, when an excessively large pressure is generated in the inside of the organic EL display device, the sealing portion 50 ruptures.

Accordingly, in case of outwardly deflecting the element substrate 10 or the sealing substrate 20 by creating the positive pressure in the organic EL display device, it is sufficient to set the deflection amount d defined in FIG. 5 or the like to 100 μm or less when the long-side size of the element substrate 10 is 76 mm. Here, an angle θ at the end portion of the element substrate 10 is 2.6×10⁻³ rad, that is, 0.15 degrees. Further, as can be understood from FIG. 3, when the long-side size of the element substrate 10 is 76 mm, it is possible to acquire a large black-spot growth prevention effect even with the deflection of approximately 30 μm. Here, the angle θ at the end portion of the element substrate 10 is 7.8×10⁻⁴ rad, that is, 0.045 degrees.

As described above, by outwardly curving the element substrate 10 with the deflection amount of approximately 30 μm or approximately 100 μm when the long-side size of the element substrate 10 is 76 mm, it is possible to prevent the growth of the black spots. Even when the size of the element substrate 10 differs, the same analogy is applicable to the element substrate 10 of different size. That is, when the long-side size of the element substrate 10 is 152 mm, the element substrate 10 may be deflected with a deflection amount of 60 μm or 200 μm. That is, by determining a ratio between the deflection amount d and the long-side size 2D of the element substrate 10, it is possible to acquire the deflection amount which prevents the growth of the black points.

By setting the outward deflection amount d to 100 μm when the long-side size 2D of the element substrate 10 is 76 mm, a ratio d/2D becomes 1.3×10⁻³, while by setting the outward deflection amount d to 30 μm when the long-side size 2D of the element substrate 10 is 76 mm, a ratio d/2D becomes 3.9×10⁻⁴. That is, to standardize the deflection amount of the element substrate 10 or the sealing substrate 20 corresponding to the above-mentioned examples, the ratio d/2D may preferably be 1.3×10⁻³ or less or 3.9×10⁻⁴ or less.

Here, from a viewpoint of manufacturing products, when the deflection amount of the element substrate 10 or the sealing substrate 20 is excessively small, a quality control becomes difficult. In view of the above, when the long-side size of the element substrate 10 is 76 mm, for example, it is possible to set the deflection amount d of the element substrate 10 to 10 μm or more. When the deflection amount is approximately 10 μm, it is possible to suppress the growth of the black points to approximately 90 μm as can be understood from FIG. 3. This value implies the large improvement in the prevention of the growth of the black points compared to a conventional example. Further, as shown in FIG. 3, by setting the deflection amount to 15 μm or more, it is possible to suppress the growth of the black points to 80 μm or less.

The case in which the long-side size of the element substrate 10 is 76 mm and the deflection amount of the element substrate 10 is 10 μm and the case in which the long-side size of the element substrate 10 is 76 mm and the deflection amount of the element substrate 10 is 15 μm are standardized as follows. That is, by setting the long-side size of the element substrate 10 to 2D and the deflection amount d to 10 μm, the ratio d/2D becomes 1.3×10⁻⁴. Further, by setting the long-side size of the element substrate 10 to 2D and the deflection amount d to 15 μm, the ratio d/2D becomes 2.0×10⁻⁴. That is, by setting the ratio d/2D to 1.3×10⁻⁴ or more or preferably to 2.0×10⁻⁴ or more, it is possible to manufacture the organic EL display device of high quality without a favorable yield.

As described above, according to the present invention, by outwardly deflecting the element substrate 10, it is possible to suppress the influence of moisture on the organic EL layer 30 formed in the inside of the element substrate 10 thus suppressing the growth of the black points. Another advantageous effect of the present invention is that so-called pushed black spots can be prevented. Here, pushed black spots implies black spots which are generated when the element substrate or the sealing substrate of the organic EL display device or both of these substrates are pushed, wherein the organic EL layer is destroyed by pushing and black spots are formed within 10 seconds after pushing the element substrate or the like. That is, the pushed black spots are generated by mechanically destroying the organic EL layer.

The organic EL layer 30 is formed by stacking approximately five extremely thin organic layers. A total thickness of the organic EL layer 30 consisting of five layers is set to less than 200 nm. Accordingly, the organic EL layer 30 easily ruptures when a force is applied to the organic EL layer 30 from the outside. To be more specific, when pressure is applied to the element substrate 10 or the sealing substrate 20 from the outside and the sealing substrate 20 is brought into contact with the organic EL layer 30, the organic EL layer 30 ruptures or a phenomenon that the organic EL layer 30 is adhered to the sealing substrate 20 so that the organic EL layer 30 is peeled off arises.

According to the present invention explained in conjunction with FIG. 1, the element substrate 10 and the sealing substrate 20 project outwardly and hence, the distance between the sealing substrate 20 and the organic EL layer 30 is originally large whereby a chance that the sealing substrate 20 and the organic EL layer 30 are brought into contact with each other is small. In addition to such constitution, the element substrate 10 or the sealing substrate 20 projects outwardly and hence, a repulsive force which resists an external force in the direction from the outside to the inside is large compared to a case in which the element substrate 10 or the sealing substrate 20 is formed of a planar plate or a case in which the element substrate 10 or the sealing substrate 20 is deflected inwardly.

In this manner, according to the present invention, it is possible to prevent not only the generation of usual black spots but also pushed black spots which are generated when the organic EL layer 30 ruptures due to an external force applied to the element substrate 10 or the sealing substrate 20.

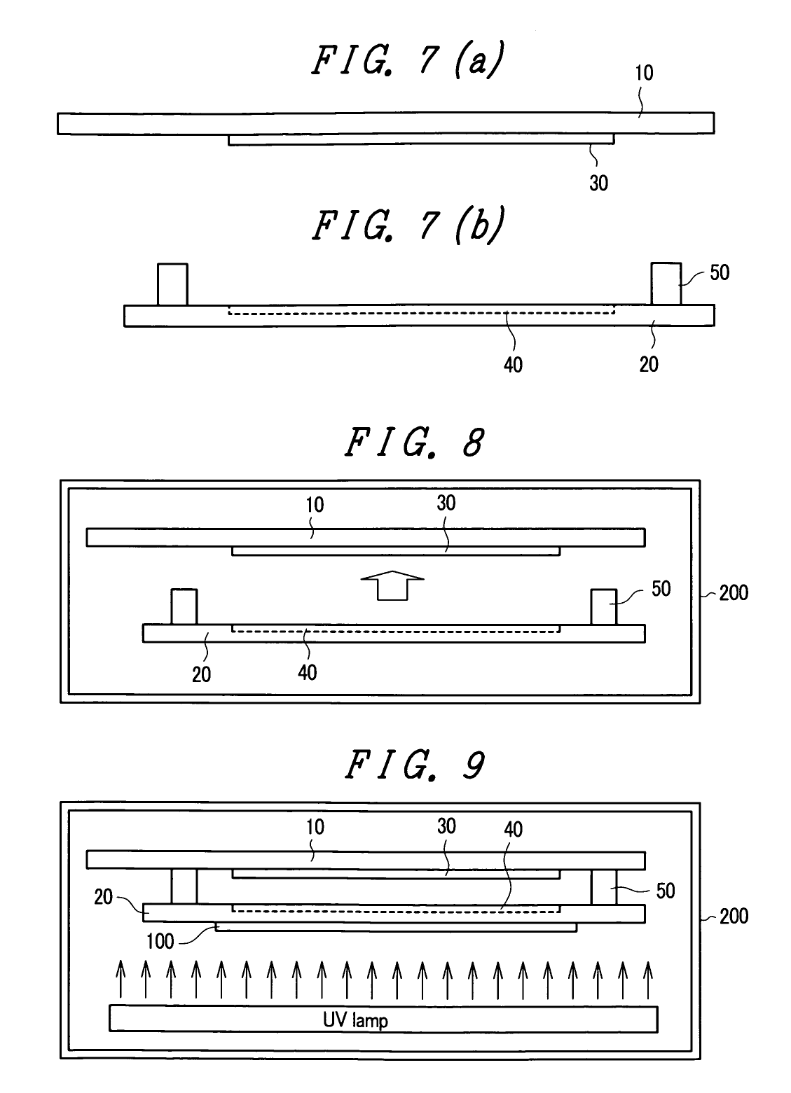

FIG. 7A to FIG. 12 shows an example of a manufacturing method which manufactures the organic EL display device in which the element substrate 10 or the sealing substrate 20 projects outwardly. FIG. 7A shows the element substrate 10 before the organic EL layers 30 are formed on the element substrate 10. The element substrate 10 is formed of a glass plate and a surface of the element substrate 10 is flat in this state. On the element substrate 10 shown in FIG. 7A, not only the organic EL layers 30 but also TFTs which control signals, signal lines, power source lines and the like are formed.

FIG. 7B shows the sealing substrate 20. A recessed portion is formed inside the sealing substrate 20, and a desiccant 40 is arranged in the recessed portion while avoiding a display part in a top-emission-type display device. The sealing substrate 20 is formed of a glass plate, and the recessed portion in which the desiccant 40 is disposed is formed by sandblast or etching. The sealing portion 50 made of a UV curing resin is formed on a periphery of the sealing substrate 20.

In this manner, the element substrate 10 and the sealing substrate 20 are separately manufactured and, in a usual manufacturing method, the element substrate 10 and the sealing substrate 20 are introduced into the inside of a chamber 200 in a reduced pressure state, as shown in FIG. 8. Nitrogen is filled in the chamber 200. Accordingly, even after the element substrate 10 and the sealing substrate 20 are sealed to each other, nitrogen is filled in the inside of the organic EL display device. Thereafter, the element substrate 10 and the sealing substrate 20 are adhered to each other by way of the sealing portion 50 made of a UV curing resin.

Then, as shown in FIG. 9, a portion of the organic EL display device where the organic EL layers 30 are present is covered with an ultraviolet ray mask (UV mask) 100, and ultraviolet rays (UV) are radiated to the sealing portion 50 using an ultraviolet ray lamp so as to temporarily curing the sealing portion 50 thus performing sealing. The portion of the organic EL display device where the organic EL layers 30 are present is, at the time of radiating ultraviolet rays, covered with the ultraviolet ray mask 100 for preventing the rupture of the organic EL layers 30 induced by the radiation of ultraviolet rays. In temporarily curing the sealing portion 50 with the radiation of the UV, such curing is carried out in the nitrogen atmosphere of pressure equal to the atmospheric pressure. Thereafter, the organic EL display device is taken into the atmosphere and is put into an electric furnace for main curing by heating. Due to such main curing, sealing of the organic EL display device is finished. The nitrogen atmosphere is set to the pressure equal to the atmospheric pressure for surely performing the adhesion of the element substrate 10 and the sealing substrate 20 using the sealing portion 50 by pushing the element substrate 10 and the sealing substrate 20 by making use of the pressure of nitrogen.

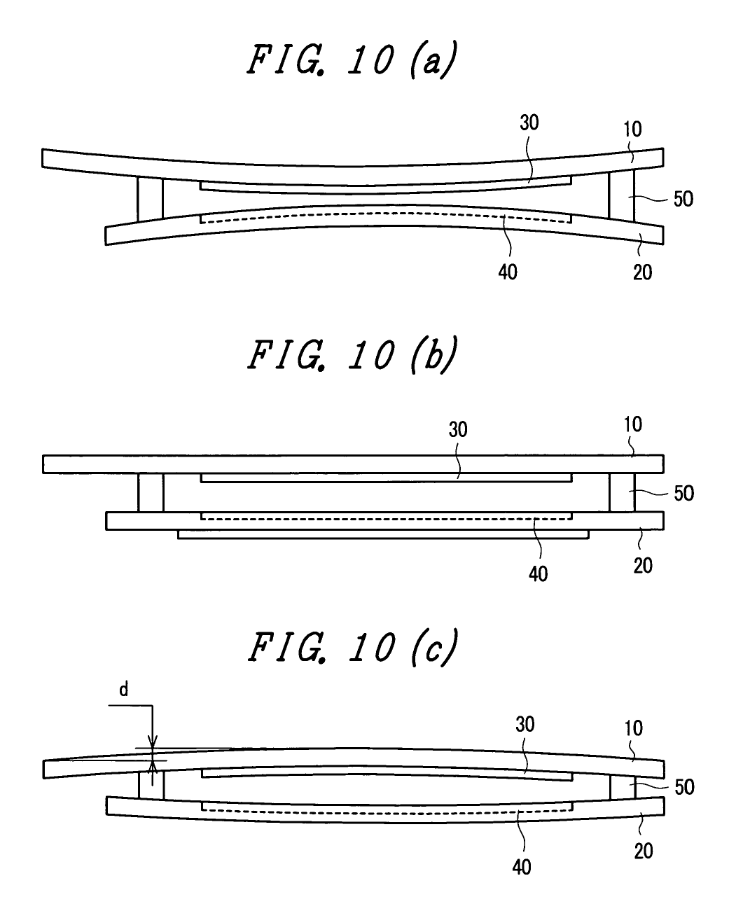

As explained above, the nitrogen atmosphere is under the reduced pressure in the stage shown in FIG. 8 and is under the pressure equal to the atmospheric pressure when the UV curing is performed. Corresponding to a degree that the pressure in the nitrogen atmosphere in the step shown in FIG. 8 is lowered relative to the atmospheric pressure, the organic EL display device after sealing takes any one of cross sections shown in FIG. 10A, FIG. 10B and FIG. 110C.

FIG. 10A shows a case in which the reduction of pressure in a lamination step shown in FIG. 8 is strong. When the pressure of nitrogen in the lamination step is small, the nitrogen pressure in the organic EL display device becomes small compared to the atmospheric pressure and hence, the element substrate 10 and the sealing substrate 20 are inwardly curved. FIG. 10B shows a case in which the pressure of nitrogen atmosphere in alamination step shown in FIG. 8 is set lower than the atmospheric pressure but is larger than the pressure of nitrogen in the case shown in FIG. 10A. By setting the pressure of nitrogen in the lamination step shown in FIG. 8 to a specified value, either the element substrate 10 or the sealing substrate 20 is not curved and is held flat even after sealing.

FIG. 10C shows a case in which the pressure of the nitrogen atmosphere in the lamination step shown in FIG. 8 is smaller than the atmospheric pressure but is larger than the pressure of nitrogen in the case shown in FIG. 10B. In this case, the element substrate 10 or the sealing substrate 20 after sealing projects outwardly. The reason the element substrate 10 or the sealing substrate 20 is outwardly curved irrespective of the pressure of nitrogen being smaller than the atmospheric pressure in the lamination step shown in FIG. 8 is that the UV curing resin used as a material of the sealing portion 50 collapses due to a deadweight of a glass plate or contracts in the UV radiation step. In this manner, even when the pressure of nitrogen is set smaller than the atmospheric pressure in an adhesion step in which the element substrate 10 and the sealing substrate 20 are adhered to each other, it is possible to curve the element substrate 10 or the sealing substrate 20 such that the element substrate 10 and the sealing substrate 20 projects outwardly.

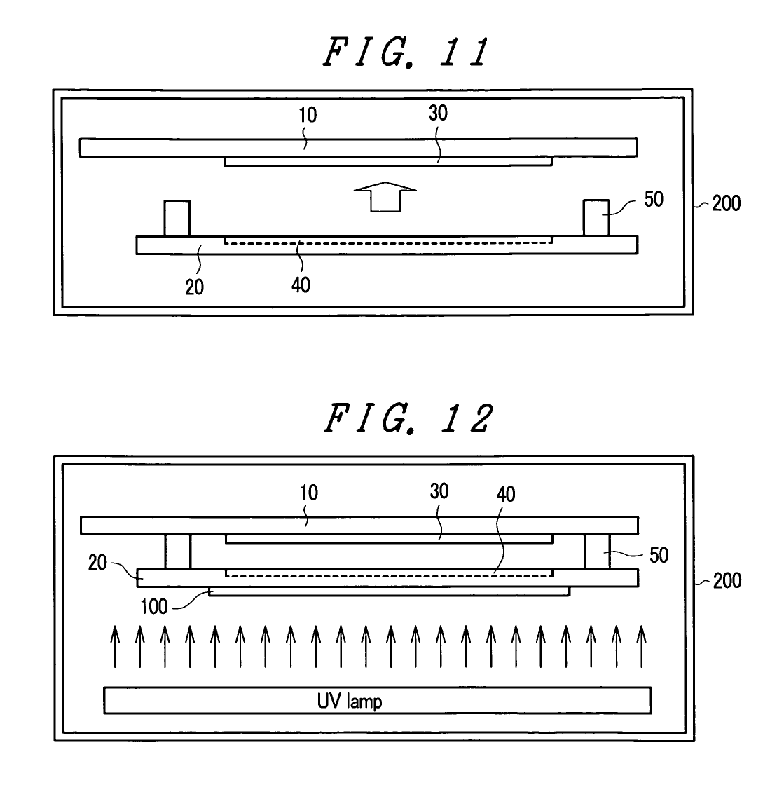

When it is necessary to curve the element substrate 10 or the sealing substrate 20 more outwardly, that is, when it is necessary to further increase the size d in FIG. 10C, steps shown in FIG. 11 and FIG. 12 may be adopted. FIG. 11 shows the step in which the element substrate 10 and the sealing substrate 20 are adhered to each other in the chamber 200 in nitrogen atmosphere. The constitution of the element substrate 10 and the sealing substrate 20 shown in FIG. 11 is substantially equal to the constitution of the element substrate 10 and the sealing substrate 20 shown in FIG. 8. The constitution shown in FIG. 11 differs from the constitution shown in FIG. 8 with respect to a point that the pressure of nitrogen atmosphere is equal to the atmospheric pressure.

Thereafter, as shown in FIG. 12, the pressure of nitrogen in the chamber 200 is elevated higher than the atmospheric pressure, and the UV radiation is performed so as to cure the sealing portion 50 made of the UV curing resin thus sealing the organic EL display device. To prevent the rupture of the organic EL layers 30 due to the UV radiation at the time of radiating the UV, an ultraviolet ray mask 100 is provided for shielding the organic EL layers 30 from the UV. In curing the sealing portion 50 by the UV radiation, the pressure of nitrogen is set larger than the atmospheric pressure for ensuring the adhesion between the sealing portion 50 and the element substrate 10 or the adhesion between the sealing portion 50 and the sealing substrate 20 by pushing the element substrate 10 or the sealing substrate 20 to the sealing portion 50.

As has been explained heretofore, even when the element substrate 10 or the sealing substrate 20 having the same plate thickness or the same size is used, by adjusting the pressure of the nitrogen atmosphere in the sealing step, it is possible to curve the element substrate 10 or the sealing substrate 20 such that the element substrate 10 or the sealing substrate 20 projects outwardly. Further, it is also possible to control an amount d that the element substrate 10 or the sealing substrate 20 projects outwardly.

In the above-mentioned embodiment, the explanation has been made with respect to the constitution in which the present invention is applied to the hollow sealing structure where a gas is filled between the sealing substrate and the element substrate. However, also when the present invention is applied to the solid sealing structure (resin in a solid form is filled in place of gas) which fixes the sealing substrate and the element substrate using a resin adhesion material, it is possible to acquire the substantially equal advantageous effects.

What is claimed is:

1. An organic EL display device in which a sealing portion is formed on a periphery of an element substrate on which organic EL layers are formed and a sealing substrate is arranged to face the element substrate in an opposed manner with the sealing portion sandwiched therebetween, wherein the element substrate has an outwardly projecting curved surface.

2. An organic EL display device according to claim 1, wherein the sealing substrate has an outwardly projecting curved surface.

3. An organic EL display device according to claim 1, wherein assuming a long-side size of the element substrate as 2D and an outward deflection amount of the element substrate as d, d/2D is set to 1.3×10⁻⁴ or more.

4. An organic EL display device according to claim 1, wherein assuming a long-side size of the element substrate as 2D and an outward deflection amount of the element substrate as d, d/2D is set to 2.0×10⁻⁴ or more.

5. An organic EL display device according to claim 1, wherein assuming a long-side size of the element substrate as 2D and an outward deflection amount of the element substrate as d, d/2D is set to 1.3×10⁻³ or less.

6. An organic EL display device according to claim 1, wherein assuming a long-side size of the element substrate as 2D and an outward deflection amount of the element substrate as d, d/2D is set to 3.9×10⁻⁴ or less.

7. An organic EL display device in which a sealing portion is formed on a periphery of an element substrate on which organic EL layers are formed and a sealing substrate is arranged to face the element substrate in an opposed manner with the sealing portion sandwiched therebetween, wherein a gas is filled in the inside of the organic EL display device, pressure in the organic EL display device is set to a positive pressure relative to the atmospheric pressure, and the element substrate has an outwardly projecting curved surface.

8. An organic EL display device according to claim 7, wherein the gas filled in the inside of the organic EL display device is nitrogen.

9. An organic EL display device according to claim 7, wherein assuming a long-side size of the element substrate as 2D and an outward deflection amount of the element substrate as d, d/2D is set to 1.3×10⁻³ or less.

10. An organic EL display device in which a sealing portion is formed on a periphery of an element substrate on which organic EL layers are formed and a sealing substrate is arranged to face the element substrate in an opposed manner with the sealing portion sandwiched therebetween, wherein the sealing portion is made of an ultraviolet curing resin, the element substrate and the sealing substrate are adhered to each other with the ultraviolet curing resin sandwiched therebetween in a nitrogen atmosphere of pressure lower than the atmospheric pressure and, thereafter, the ultraviolet curing resin is cured by ultraviolet rays in a nitrogen atmosphere of pressure substantially equal to the atmospheric pressure, and the element substrate has an outwardly projecting curved surface.

11. An organic EL display device in which a sealing portion is formed on a periphery of an element substrate on which organic EL layers are formed and a sealing substrate is arranged to face the element substrate in an opposed manner with the sealing portion sandwiched therebetween, wherein the sealing portion is made of an ultraviolet curing resin, the element substrate and the sealing substrate are adhered to each other with the ultraviolet curing resin sandwiched therebetween in a nitrogen atmosphere of pressure substantially equal to the atmospheric pressure and, thereafter, the ultraviolet curing resin is cured by ultraviolet rays in a nitrogen atmosphere of pressure higher than the atmospheric pressure, and the element substrate has an outwardly projecting curved surface.
